(19) United States
(12) Patent Application Publication
(10) Pub. No.: US 2026/0121103 A1
(43) Pub. Date: Apr. 30, 2026

(54) CATHODE ACTIVE MATERIAL FOR LITHIUM-ION SECONDARY BATTERY

(71) Applicant: TOYOTA JIDOSHA KABUSHIKI KAISHA, Toyota-shi (JP)

(72) Inventors: Momoko PROCTER, Seto-shi (JP); Yuji Mahara, Seto-shi (JP); Taku Kinoshita, Toyota-shi (JP)

(73) Assignee: TOYOTA JIDOSHA KABUSHIKI KAISHA, Toyota-shi (JP)

(21) Appl. No.: 19/343,216

(22) Filed: Sep. 29, 2025

(30) Foreign Application Priority Data
Oct. 31, 2024 (JP) 2024-191776

(51) Int. Cl. H01M 10/0525; H01M 4/02; H01M 4/36; H01M 4/525

(52) U.S. Cl. CPC H01M 10/0525; H01M 4/366; H01M 4/525; H01M 2004/021; H01M 2004/028

(57) ABSTRACT

A cathode active material for a lithium-ion secondary battery includes a lithium transition metal composite oxide. The lithium transition metal composite oxide has a layered structure. The layered structure is provided by alternately stacking lithium layers and transition metal layers. The transition metal layer contains at least nickel. The layered structure satisfies the relationship “1.20≤d_{Li}/d_{TM}≤1.25,” where d_{Li} represents the interlayer distance of the lithium layer in the layered structure, and d_{TM} represents the interlayer distance of the transition metal layer in the layered structure.

### CROSS-REFERENCE TO RELATED APPLICATION

This application claims priority to Japanese Patent Application No. 2024-191776 filed on Oct. 31, 2024. The disclosure of the above-identified application, including the specification, drawings, and claims, is incorporated by reference herein in its entirety.

### BACKGROUND

### 1. Technical Field

The present disclosure relates to cathode active materials for lithium-ion secondary batteries.

### 2. Description of Related Art

Japanese Unexamined Patent Application Publication (Translation of PCT Application) No. 2023-516229 (JP 2023-516229 A) discloses a cathode material that contains polycrystalline particles and either single-crystal particles or single-crystal-like particles, and has a particle size distribution satisfying the relationship “1.5≤(D95-D5)/D50≤2.5.”

### SUMMARY

There is a demand for lithium-ion secondary batteries having high energy density. For example, it has conventionally been proposed to improve the energy density by enhancing the packing properties of a cathode active material through adjustment of the particle size distribution of the cathode active material. In order to achieve even higher energy density, it is desired to increase the initial discharge capacity of the cathode active material.

An object of the present disclosure is to provide a cathode active material for a lithium-ion secondary battery that has a large initial discharge capacity.
1. A cathode active material for a lithium-ion secondary battery includes a lithium transition metal composite oxide. The lithium transition metal composite oxide has a layered structure. The layered structure is provided by alternately stacking lithium layers and transition metal layers. The transition metal layer contains at least nickel. The layered structure satisfies the relationship “1.20≤d_{Li}/d_{TM}≤1.25,” where d_{Li} represents the interlayer distance of the lithium layer in the layered structure, and d_{TM} represents the interlayer distance of the transition metal layer in the layered structure.

The layered structure is provided by alternately stacking lithium (Li) layers and transition metal (TM) layers. The initial discharge capacity depends on the extent to which Lit ions can be reinserted into the Li layers after being extracted therefrom. The interlayer distance d_{Li} refers to the distance, in the stacking direction, between the oxygen (O) site that forms the upper surface of an Li layer and the O site that forms the lower surface of the Li layer. In other words, the interlayer distance d_{Li} represents the thickness of the Li layer. The interlayer distance dry refers to the distance, in the stacking direction, between the O site that forms the upper surface of a TM layer and the O site that forms the lower surface of the TM layer. In other words, the interlayer distance d_{TM} represents the thickness of the TM layer. When the interlayer distance ratio d_{Li}/d_{TM} is 1.20 or more, an increase in the initial discharge capacity is expected. Although this is merely an assumption, it is considered that relative expansion of the Li layer with respect to the TM layer may improve the diffusion properties of Lit ions, thereby increasing the initial discharge capacity. However, when the interlayer distance ratio d_{Li}/d_{TM} exceeds 1.25, the initial discharge capacity may rather decrease. Hereinafter, the cathode active material for a lithium-ion secondary battery may be simply referred to as “cathode active material,” and the lithium-ion secondary battery may be simply referred to as “battery.”
2. The cathode active material according to “1” described above may include, for example, the following configuration. The lithium transition metal composite oxide has a composition represented by the general formula “LiₓNiₐCo_{b}Mn_{c}O_{y}.” In the general formula, “x, a, b, c, and y” satisfy the following relationships: “0.1≤x≤1.5,” “0.5≤a≤1.0,” “0≤b≤0.3,” “0≤c≤0.3,” “a+b+c=1.0,” and “1.5≤y≤2.1.”

The TM layer may further contain cobalt (Co) and manganese (Mn) in addition to nickel (Ni). The main component of the TM layer may be Ni. In other words, the Ni composition ratio “a” may be 0.5 or more. When the main component of the TM layer is Ni, an increase in the initial discharge capacity is expected.
3. The cathode active material according to “1” or “2” described above may include, for example, the following configuration. The lithium transition metal composite oxide is in the form of a powder. In the powder, the proportion of single-crystal particles to the total number of the single-crystal particles and polycrystalline particles is 70% or more. The single-crystal particles each contain one to ten primary particles. The polycrystalline particles each contain more than ten primary particles.

When the proportion of single-crystal particles is 70% or more, there is a possibility that, for example, cycle characteristics may be improved.
4. The cathode active material according to any one of “1” to “3” described above may include, for example, the following configuration. The layered structure further satisfies the following relationships: “2.596 Å≤d_{Li}≤2.614 Å” and “2.133 Å≤d_{TM}≤2.142 Å.”

When the interlayer distances are within the above ranges, an increase in the initial discharge capacity is expected.
5. The cathode active material according to any one of “1” to “4” described above may include, for example, the following configuration. The cathode active material has an initial discharge capacity of 220 mAh/g or more at 25° C.

For example, in the embodiment disclosed in JP 2023-516229 A, a cathode active material having an initial discharge capacity of 206 mAh/g is disclosed. In contrast, the present disclosure can provide a cathode active material having an initial discharge capacity of 220 mAh/g or more.

An embodiment of the present disclosure (hereinafter also referred to as “present embodiment”) and an example of the present disclosure (hereinafter also referred to as “present example”) will be described. However, the present embodiment and the present example are not intended to limit the technical scope of the present disclosure. The present embodiment and the present example are illustrative in all respects. The present embodiment and the present example are not restrictive. The technical scope of the present disclosure includes all modifications that fall within the meaning and scope equivalent to the claims. For example, it is originally intended that any configurations may be extracted from the embodiment and combined as desired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of a layered structure; and

FIG. 2 is a table showing experimental results.

### DETAILED DESCRIPTION OF EMBODIMENTS

### Terms and Phrases

The terms “Comprise,” “include,” “have,” and their variations are open-ended expressions. A configuration expressed in an open-ended manner may or may not include additional elements in addition to essential elements. The term “consist of” is a closed-ended expression. Even a configuration expressed in a closed-ended manner may include additional elements such as incidental impurities or elements irrelevant to the target technology. The term “substantially consist of” is a semi-closed-ended expression. In a configuration expressed in a semi-closed-ended manner, it is allowed to add elements that do not substantially affect the fundamental and novel characteristics of the target technology.

Numerical values may be expressed in significant figures. Measured values may be the averages of multiple measurements, unless otherwise specified. The number of measurements may be three or more, five or more, or 10 or more. Typically, the larger the number of measurements, the higher the reliability of the average is expected to be. Measured values may be rounded based on the number of significant figures. Measured values may include errors such as those associated with the detection limits of measurement devices.

The devices, software, etc. used for measuring various values are merely examples. Devices etc. equivalent to those exemplified herein may be used. When an equivalent device is used, the measurement conditions may be adjusted in accordance with the device.

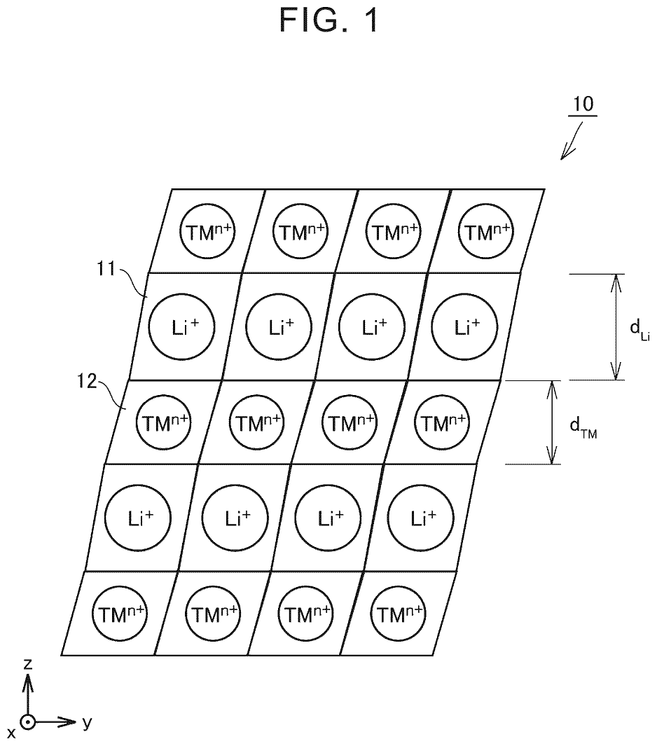

FIG. 1 is a conceptual diagram of a layered structure. A layered structure 10 includes an Li layer 11 and a TM layer 12. The interlayer distance d_{Li} indicates the interlayer distance of the Li layer 11. The interlayer distance d_{TM} indicates the interlayer distance of the TM layer 12. Each interlayer distance is identified by Rietveld analysis of the cathode active material. First, a powder X-ray diffraction (XRD) pattern of a cathode active material is obtained. For example, the XRD measurement may be performed at beamline BL5S2 of the Aichi Synchrotron Radiation Center. For the measurement, a sample (cathode active material) is sealed in a glass capillary tube (inner diameter: 0.5 mm). The irradiation energy is 17 keV. The measurement time is 10 minutes.

Subsequently, the XRD pattern is analyzed using the analysis software GSAS-II. Refinement is performed using a phase with the space group R-3m. As an example, a procedure will be described for a case where the cathode active material has a composition of LiNi_{0.90}Co_{0.05}Mn_{0.05}O₂. The site occupancy of Li at the 3a site (Li layer site) is represented as “1-x,” and the site occupancy of Ni at this site is represented as “x.” At the 3b site (TM layer site), the site occupancy of Ni is represented as “0.90-x,” the site occupancy of Co as “0.05,” the site occupancy of Mn as “0.05,” and the site occupancy of Li as “x.” The most probable structure is estimated by refining “x.” In this refinement, the atomic position in the z-axis direction at the 6c site (O-site) is set as a free parameter, whereby the interlayer distance d_{Li} and the interlayer distance d_{TM} are determined.

The “site occupancy” indicates the fraction of atoms (or ions) of an element of interest relative to the total number of atoms occupying the site. The site occupancy may also be expressed as a molar fraction.

The chemical composition of the cathode active material may be measured by inductively coupled plasma atomic emission spectroscopy (ICP-AES). A sample solution is prepared by dissolving 0.1 g of the sample (cathode active material) in a mixed acid (10 mL) of hydrochloric acid and sulfuric acid. The sample solution is diluted to an appropriate concentration using a volumetric flask. After the dilution, compositional analysis is performed using an ICP-AES device. For example, a product such as PS3520UVDDII (manufactured by Hitachi High-Tech Corporation) may be used.

A stoichiometric formula represents a representative composition of a compound. The compound may have a non-stoichiometric composition. For example, “Al₂O₃” is not limited to compounds having a mole ratio of “Al/O=2/3.” Unless otherwise specified, “Al₂O₃” refers to compounds containing Al and O in any mole ratio. For example, the compound may be doped with a trace element. Al and O may be partially substituted with another element.

The term “primary particle” refers to the smallest unit of a particle, recognized as a solid particle that defines the boundary between particles and that cannot be divided any further. The number of primary particles contained in a single-crystal or polycrystalline particle is counted using scanning electron microscope (SEM) images of the powder. The magnification of the images is, for example, 10,000×. A primary particle that exists independently, or an aggregate of 2 to 10 primary particles, is regarded as a single-crystal particle. An aggregate of more than 10 primary particles is regarded as a polycrystalline particle.

The initial discharge capacity is measured using a coin cell. The coin cell refers to a cell in which a power generation element is housed in a coin-shaped case. First, a disk-shaped electrode is fabricated. The electrode has a diameter of 16 mm. The electrode contains, for example, 90% or more of a cathode active material by mass fraction. In addition to the cathode active material, the electrode may optionally include a conductive material and a binder. The counter electrode is metallic lithium. The initial discharge capacity is measured by discharging the coin cell at a rate of 0.1 C from 4.3 V to 3.0 V at 25° C. At a rate of 1 C, the theoretical capacity of the coin cell is discharged over the course of one hour. The initial discharge capacity per unit mass is obtained by dividing the initial discharge capacity by the mass of the cathode active material contained in the electrode. The unit of the initial discharge capacity is mAh/g. The initial discharge capacity is also referred to as “specific capacity.”

“D50” refers to the particle size at which the cumulative frequency reaches 50% in a volume-based particle size distribution (cumulative distribution). D50 may be measured by, for example, a laser diffraction method.

### Cathode Active Material

The cathode active material is for use in a battery. The battery may be a liquid electrolyte battery or an all-solid-state battery. The battery may have any structure. The battery may have, for example, a wound or stacked power generation element. The battery may have, for example, a unipolar structure or a bipolar structure.

The cathode active material contains a lithium transition metal composite oxide. A lithium transition metal composite oxide refers to a compound containing Li, TM, and O. The lithium transition metal composite oxide has a layered structure. The layered structure exhibits a crystal structure belonging to the space group R-3m. The layered structure is provided by alternately stacking Li layers and TM layers. The TM layer contains a transition metal. The TM layer contains at least Ni. The TM layer may further contain any other element in addition to Ni. The TM layer may contain, for example, at least one selected from the group consisting of Co, Mn, and Al. The site occupancy of Ni in the TM layer may be, for example, 0.3 or more, 0.4 or more, 0.5 or more, 0.6 or more, 0.7 or more, 0.8 or more, or 0.9 or more. The site occupancy rate of Ni in the TM layer may be, for example, 1 or less, or 0.95 or less. The site occupancy may be determined by Rietveld analysis. The main component of the TM layer may be Ni. For example, when the site occupancy of Ni in the TM layer is 0.5 or more, Ni is regarded as the main component of the TM layer. When the main component of the TM layer is Ni, an increase in the initial discharge capacity is expected.

In the layered structure, the interlayer distance ratio d_{Li}/d_{TM} is 1.20 or more and 1.25 or less. The interlayer distance ratio d_{Li}/d_{TM} may be, for example, 1.21 or more, 1.22 or more, 1.23 or more, or 1.24 or more. The interlayer distance ratio d_{Li}/d_{TM} may be, for example, 1.24 or less, 1.23 or less, 1.22 or less, or 1.21 or less. The layered structure may satisfy, for example, the relationship “1.20≤d_{Li}/d_{TM}≤1.23.” The layered structure may satisfy, for example, the relationship “1.21≤d_{Li}/d_{TM}≤1.23.”

When the layered structure satisfies the relationship “1.20≤d_{Li}/d_{TM}≤1.25,” an increase in the initial discharge capacity is expected. The cathode active material may have an initial discharge capacity of, for example, 220 mAh/g or more. The initial discharge capacity may be, for example, 221 mAh/g or more, 222 mAh/g or more, 223 mAh/g or more, 224 mAh/g or more, 225 mAh/g or more, 226 mAh/g or more, 227 mAh/g or more, 228 mAh/g or more, 229 mAh/g or more, or 230 mAh/g or more. The initial discharge capacity may be, for example, 240 mAh/g or less, 230 mAh/g or less, 228 mAh/g or less, or 226 mAh/g or less.

The interlayer distance d_{Li} may be, for example, 2.596 Å or more and 2.614 Å or less (0.2596 nm or more and 0.2614 nm or less). The interlayer distance d_{Li} may be, for example, 2.600 Å or more, 2.603 Å or more, 2.606 Å or more, 2.609 Å or more, or 2.612 Å or more. The interlayer distance d_{Li} may be, for example, 2.612 Å or less, 2.609 Å or less, 2.606 Å or less, 2.603 Å or less, or 2.600 Å or less.

The interlayer distance d_{TM} may be, for example, 2.133 Å or more and 2.142 Å or less. The interlayer distance d_{TM} may be, for example, 2.135 Å or more, 2.137 Å or more, 2.139 Å or more, or 2.141 Å or more. The interlayer distance d_{TM} may be, for example, 2.141 Å or less, 2.139 Å or less, 2.137 Å or less, or 2.135 Å or less.

The lithium transition metal composite oxide may have a composition represented by, for example, the general formula “LiₓNiₐCo_{b}Mn_{c}O_{y}.” In the general formula, the Li composition ratio x may satisfy, for example, the relationship “0.1≤x≤1.5.” The Li composition ratio “x” may be, for example, 0.4 or more, 0.6 or more, 0.8 or more, 1.0 or more, 1.2 or more, or 1.4 or more. The Li composition ratio “x” may be, for example, 1.4 or less, or 1.2 or less.

In the above general formula, the O composition ratio “y” may satisfy, for example, the relationship “1.5≤y≤2.1.” The O composition ratio “y” may be, for example, 1.6 or more, 1.7 or more, 1.8 or more, 1.9 or more, or 2.0 or more. The O composition ratio “y” may be, for example, 2.0 or less, 1.9 or less, 1.8 or less, 1.7 or less, or 1.6 or less.

In the above general formula, the Ni composition ratio “a”, the Co composition ratio “b,” and the Mn composition ratio “c” may satisfy the relationship “a+b+c=1.0.” The Ni composition ratio “a” may satisfy, for example, the relationship “0.5≤a≤1.0.” The Ni composition ratio “a” may be, for example, 0.6 or more, 0.7 or more, 0.8 or more, or 0.9 or more. The Ni composition ratio “a” may be, for example, 0.9 or less, 0.8 or less, 0.7 or less, or 0.6 or less.

In the above general formula, the Co composition ratio “b” may satisfy, for example, the relationship “0≤b≤0.3.” The Co composition ratio “b” may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Co composition ratio “b” may be, for example, 0.025 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

In the above general formula, the Mn composition ratio “c” may satisfy, for example, the relationship “0≤c≤0.3.” The Mn composition ratio “c” may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Mn composition ratio “c” may be, for example, 0.025 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

In the above general formula, all or part of Mn may be substituted with Al etc. That is, the lithium transition metal composite oxide may have a composition represented by, for example, the general formula “LiₓNiₐCo_{b}Al_{c}O_{y}.” The range of the Al composition ratio “c” is the same as that of the Mn composition ratio “c” described above. Any dopant may be added to the lithium transition metal composite oxide.

The dopant herein refers to an element other than Li, Ni, Co, Mn, and O. The dopant may include, for example, at least one selected from the group consisting of Zr, Mo, W, Mg, Ca, Na, Fe, Cr, Zn, Si, Sn, Al, and Ag. The composition ratio of the dopant may be, for example, 0.005 or more, 0.01 or more, 0.02 or more, 0.03 or more, or 0.04 or more. The composition ratio of the dopant may be, for example, 0.05 or less, 0.04 or less, 0.03 or less, 0.02 or less, or 0.01 or less.

The cathode active material may be in the form of a powder. The D50 of the powder may be, for example, 1 μm or more, 3 μm or more, 5 μm or more, 10 μm or more, or 15 μm or more. The D50 of the powder may be, for example, 30 μm or less, 20 μm or less, or 10 μm or less.

The powder may contain single-crystal particles and polycrystalline particles. The single-crystal particles may have a smaller specific surface area than the polycrystalline particles. Increasing the proportion of the single-crystal particles to the total number of the single-crystal and polycrystalline particles is expected to suppress side reactions leading to capacity degradation. The proportion of the single crystal particles to the total number of the single-crystal and polycrystalline particles may be, for example, 70% or more. When the proportion of the single-crystal particles is 70% or more, improvement in cycle characteristics, for example, can be expected. There is also a possibility that, for example, cycle characteristics under high-temperature conditions (e.g., 60° C.) may be improved. The proportion of the single-crystal particles may be, for example, 50% or more, 60% or more, 70% or more, 80% or more, or 90% or more. The proportion of the single-crystal particles may be, for example, 100% or less, 90% or less, 80% or less, 70% or less, or 60% or less.

The number of primary particles constituting a single-crystal particle may be, for example, nine or fewer, eight or fewer, seven or fewer, six or fewer, five or fewer, four or fewer, three or fewer, or two or fewer. A single-crystal particle substantially consisting of one primary particle is also referred to as a single particle. The number of primary particles constituting a polycrystalline particle may be, for example, 15 or more, 20 or more, 25 or more, or 50 or more. The number of primary particles constituting a polycrystalline particle may be, for example, 100 or fewer, 50 or fewer, 25 or fewer, or 20 or fewer.

### Sample Fabrication

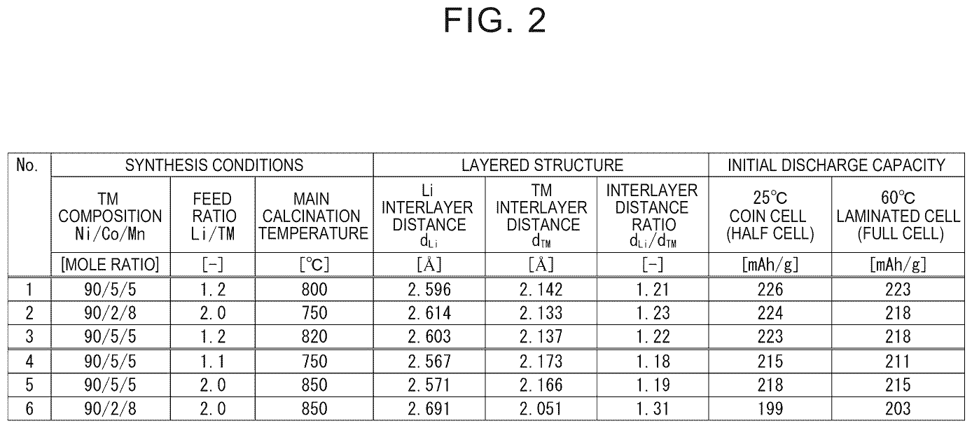

FIG. 2 is a table showing experimental results. Samples No. 1 to No. 6 were fabricated by the following procedure.

### Synthesis of TM Precursor (TM Hydroxide)

A precursor solution is prepared by dissolving NiSO₄, CoSO₄, and MnSO₄ in deionized water. The mixing ratio of NiSO₄, CoSO₄, and MnSO₄ is adjusted such that the mole ratio of “Ni/Co/Mn” matches the value shown in the “TM Composition” column under “Synthesis Conditions” in FIG. 2. The molar concentration of the raw material solution is 0.2%.

A predetermined amount of NH₃ aqueous solution is placed into a reaction vessel. The interior of the reaction vessel is purged with nitrogen while being stirred with a stirrer. NaOH is added to the reaction vessel to adjust the pH of the aqueous solution to an alkaline level. While the temperature and pH of the aqueous solution are adjusted to remain within a certain range (substantially constant), the precursor solution is added dropwise, thereby forming a precipitate of a TM hydroxide. The precipitate is subjected to dehydration and pre-calcination. The pre-calcination temperature is from 120° C. to 220° C. The pre-calcination time is from four hours to ten hours. The pre-calcination pressure is from 0.2 MPa to 1.0 MPa.

After the pre-calcination, the precipitate is washed with water. The residue (TM hydroxide) is recovered by filtration. The TM hydroxide is dried at 110° C. for 12 hours to remove moisture. After drying, the TM hydroxide is mixed with an Li compound (LiOH) to form a mixture. The Li compound may be, for example, Li₂CO₃. The mixing ratio is adjusted such that the mole ratio “Li/TM,” that is, the ratio of the amount of Li to the total amount of TM, matches the value shown in the “Feed Ratio” column under “Synthesis Conditions” in FIG. 2. When Li/TM is greater than 1, LiOH is considered to be in excess relative to the TM hydroxide. Excess LiOH tends to promote the formation of single-crystal particles of the lithium transition metal composite oxide. That is, the proportion of single-crystal particles in the powder is expected to be 70% or more.

In a calcination furnace, the mixture is subjected to main calcination, thereby forming a calcined product. The calcination furnace may be, for example, a muffle furnace. The main calcination time is from five hours to 15 hours. The main calcination temperature is as shown in the “Main Calcination Temperature” column under “Synthesis Conditions” in FIG. 2.

The calcined product is crushed in an agate mortar until the particle size becomes 0.2 mm or smaller, thereby forming a crushed product. The crushed product is dispersed in 500 mL of pure water to form a slurry. The slurry is vigorously stirred for one minute. The slurry is then filtered using filter paper and a Buchner funnel. The resulting residue is rinsed with 500 mL of pure water to form a cake. The cake is dried under vacuum at 90° C. After drying, the cake is crushed again in an agate mortar to adjust the particle size to a predetermined level. Instead of using an agate mortar, the cake may be crushed using, for example, a laboratory mill. A lithium transition metal composite oxide is produced in this manner. In Samples No. 1, No. 3, No. 4, and No. 5, the composition of the lithium transition metal composite oxide is LiNi_{0.90}Co_{0.05}Mn_{0.05}O₂. In Samples No. 2 and No. 6, the composition of the lithium transition metal composite oxide is LiNi_{0.90}Co_{0.02}Mn_{0.08}O₂. The interlayer distances of each sample are measured by Rietveld analysis.

### Evaluation

### Coin Cell (Half Cell)

An electrode containing a cathode active material is prepared. A coin cell including the electrode is prepared. The initial discharge capacity is measured under the conditions described above.

### Laminated Cell (Full Cell)

A laminated cell is prepared. The laminated cell refers to a cell in which a power generation element is housed in a pouch made of an aluminum (Al) laminate film. The configuration of the power generation element is as follows.
Cathode: cathode active material (lithium transition metal composite oxide), electrically conductive material (acetylene black)
Anode: anode active material (natural graphite)

$$Electrolyte : {LiPF}_{6} ( 1 mol / L ) , EC / DMC / EMC = 3 / 4 / 3 ( volume ratio )$$

The cathode and the anode are each produced by coating the surface of a substrate (metal foil) with the slurry. For example, a film applicator (with a film thickness control function) manufactured by Allgood Co., Ltd. is used as a coating device. After the slurry coating, the coating film is dried at 80° C. for five minutes.

A cycle test is conducted on the laminated cell under the following conditions.
Ambient temperature: 60° C.
Number of cycles: 100
Current rate: 0.3 C
Voltage range: 4.25 V to 2.5 V

### Experimental Results

In FIG. 2, the initial discharge capacity tends to increase when the relationship “1.20≤d_{Li}/d_{TM}≤1.25” is satisfied. When this relationship is satisfied, an initial discharge capacity of 220 mAh/g or more is exhibited at 25° C.

The full cell is capable of being repeatedly charged and discharged. The cathode active material is considered to be suitable for use in secondary batteries.

What is claimed is:

1. A cathode active material for a lithium-ion secondary battery, the cathode active material comprising a lithium transition metal composite oxide, wherein:
the lithium transition metal composite oxide has a layered structure;
the layered structure is formed by alternately stacking lithium layers and transition metal layers;
the transition metal layer contains at least nickel; and
the layered structure satisfies the following relationship:
$$20 \leq {d}_{Li} / {d}_{TM} \leq 1.25 ,$$
where d_{Li} represents an interlayer distance of the lithium layer in the layered structure, and
d_{TM} represents an interlayer distance of the transition metal layer in the layered structure.

2. The cathode active material according to claim 1, wherein the lithium transition metal composite oxide has a composition represented by the following general formula: 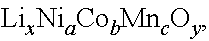
where x, a, b, c, and y satisfy the following relationships: 0.1≤x≤1.5, 0.5≤a≤1.0, 0≤b≤0.3, 0≤c≤0.3, a+b+c=1.0, and 1.5≤y≤2.1.

3. The cathode active material according to claim 1, wherein:
the lithium transition metal composite oxide is in a form of a powder;
in the powder, a proportion of single-crystal particles to a total number of the single-crystal particles and polycrystalline particles is 70% or more;
the single-crystal particles each contain one to ten primary particles; and
the polycrystalline particles each contain more than ten primary particles.

4. The cathode active material according to claim 1, wherein the layered structure further satisfies the following relationships:
$$2.596 Å \leq {d}_{Li} \leq 2.614 Å , and$$
$$2.133 Å \leq {d}_{TM} \leq 2.1 \; 42 Å .$$

5. The cathode active material according to claim 1, wherein the cathode active material has an initial discharge capacity of 220 mAh/g or more at 25° C.
